(19) United States
(12) Patent Application Publication
(10) Pub. No.: US 2026/0351242 A1
(43) Pub. Date: Nov. 5, 2026

(54) TIMING OPTIMIZATION FOR AUTOMATIC VIDEO DUBBING

(71) Applicant: GOOGLE LLC, Mountain View, CA (US)

(72) Inventor: Xiao Zhang, Sunnyvale, CA (US)

(21) Appl. No.: 19/196,176

(22) Filed: May 1, 2025

(51) Int. Cl. G10L 13/08; G06F 17/11; G06F 40/58; G10L 15/26

(52) U.S. Cl. CPC G10L 13/08; G06F 17/11; G06F 40/58; G10L 15/26

(57) ABSTRACT

Automatic video dubbing includes obtaining an input video including a sequence of input images and input speech audio in a first language and automatically generating a dubbed video including segments of automatically generated synthesized speech audio in a second language. Automatically generating the dubbed video includes automatically generating a source transcript of the input speech, automatically generating a translated transcript in the second language by translating the source transcript, automatically generating synthesis optimization data by solving a quadratic optimization problem formulated to synchronize the segments of automatically generated synthesized speech audio with the sequence of input images, automatically synthesizing the segments of automatically generated synthesized speech audio in accordance with the synthesis optimization data and the translated transcript, and including the segments of automatically generated synthesized speech audio in the dubbed video.

### BACKGROUND

Digital video can be used, for example, on the internet, for remote business meetings via video conferencing, high-definition video entertainment, video advertisements, or sharing of user-generated content. Digital video may include audio content, such as an audio stream or track, synchronized with video content. The audio content may be in a language. Accordingly, it would be advantageous to provide automatic translation and dubbing of video content.

### SUMMARY

This application relates to automatic translation and dubbing of video content. Disclosed herein are aspects of systems, methods, and apparatuses for timing optimization for automatic video dubbing.

Variations in these and other aspects will be described in additional detail hereafter.

An aspect is a method for automatic video dubbing. Automatic video dubbing may include obtaining an input video, automatically generating a dubbed video, and outputting the dubbed video. The input video may include a sequence of input images and input audio. The input audio may include input speech audio in a first language and other audio. The dubbed video may include the sequence of input images, the other audio, and segments of automatically generated synthesized speech audio in a second language. Automatically generating the dubbed video may include automatically generating a source transcript of the input speech audio in the first language using a machine learning speech recognition model, automatically generating a translated transcript in the second language by translating the source transcript using a machine learning translation model, automatically generating synthesis optimization data by solving a quadratic optimization problem formulated to synchronize the segments of automatically generated synthesized speech audio with the sequence of input images, automatically synthesizing the segments of automatically generated synthesized speech audio in accordance with the synthesis optimization data and the translated transcript using a machine learning text-to-speech synthesis model, and including the segments of automatically generated synthesized speech audio in the dubbed video in accordance with the synthesis optimization data.

An aspect is a non-transitory computer-readable storage medium comprising executable instructions that, when executed by a processor, facilitate performance of operations comprising automatic video dubbing. Automatic video dubbing may include obtaining an input video, automatically generating a dubbed video, and outputting the dubbed video. The input video may include a sequence of input images and input audio. The input audio may include input speech audio in a first language and other audio. The dubbed video may include the sequence of input images, the other audio, and segments of automatically generated synthesized speech audio in a second language. Automatically generating the dubbed video may include automatically generating a source transcript of the input speech audio in the first language using a machine learning speech recognition model, automatically generating a translated transcript in the second language by translating the source transcript using a machine learning translation model, automatically generating synthesis optimization data by solving a quadratic optimization problem formulated to synchronize the segments of automatically generated synthesized speech audio with the sequence of input images, automatically synthesizing the segments of automatically generated synthesized speech audio in accordance with the synthesis optimization data and the translated transcript using a machine learning text-to-speech synthesis model, and including the segments of automatically generated synthesized speech audio in the dubbed video in accordance with the synthesis optimization data.

An aspect is an apparatus for automatic video dubbing. The apparatus may include a non-transitory computer-readable medium and a processor configured to execute instructions stored on the non-transitory computer-readable medium to obtain an input video, automatically generate a dubbed video, and output the dubbed video. The input video may include a sequence of input images and input audio. The input audio may include input speech audio in a first language and other audio. The dubbed video may include the sequence of input images, the other audio, and segments of automatically generated synthesized speech audio in a second language. To automatically generate the dubbed video, the processor may be configured to execute the instructions to automatically generate a source transcript of the input speech audio in the first language, wherein, to automatically generate the source transcript, the processor is configured to execute the instructions to use a machine learning speech recognition model, automatically generate a translated transcript in the second language by translate the source transcript, wherein, to automatically generate the translated transcript, the processor is configured to execute the instructions to use a machine learning translation model, automatically generate synthesis optimization data, wherein, to automatically generate the synthesis optimization data, the processor is configured to execute the instructions to solve a quadratic optimization problem formulated to synchronize the segments of automatically generated synthesized speech audio with the sequence of input images, automatically synthesize the segments of automatically generated synthesized speech audio in accordance with the synthesis optimization data and the translated transcript, wherein, to automatically synthesize the segments of automatically generated synthesized speech audio, the processor is configured to execute the instructions to use a machine learning text-to-speech synthesis model, and include the segments of automatically generated synthesized speech audio in the dubbed video in accordance with the synthesis optimization data.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in timing optimization for automatic video dubbing in accordance with implementations of this disclosure.

FIG. 4 is a flowchart diagram of an example of timing optimization for automatic video dubbing in accordance with implementations of this disclosure.

FIG. 5 is a flowchart diagram of an example of automatically generating synthesis optimization data in accordance with implementations of this disclosure.

### DETAILED DESCRIPTION

Video content includes image content, such as a sequence of images, and may include audio content synchronized with the image content. The audio content may include spoken, or speech, audio content and other audio content, such as background audio. The speech audio content may be in a language. The utility of video content including speech audio content in a first language may be limited for viewers other than viewers that understand the first language.

Some systems improve the utility of video content that includes input, original, or source speech audio content in a limited set of input, original, or source languages, such as in one language, by automatically dubbing in speech audio content in one or more other languages. For example, automatically dubbing speech audio content may include automatically transcribing the input speech audio in the input language, automatically translating the transcript of the input speech audio in the input language to another language, automatically synthesizing speech audio in the other language, and automatically dubbing, or merging, the synthesized speech audio with the input images to generate a dubbed video. Because languages vary, such as with respect to verbosity, and because automatic translation prioritizes accuracy over audio duration, synchronization between the dubbed audio and the sequence of images may be inaccurate, such as with respect to maintaining context windows, lip or body movement, or other visual to audio synchronization, reducing the utility, quality, or both, of automatically dubbed video content

Effective systems that improve the synchronization, or temporal alignment, of dubbed audio with the input sequence of images by implementing isometric, or duration-aware, machine translation that produces a translation that has a similar length, such as in terms of characters or phenomes, to the input speech content are unavailable.

Available systems that seek to improve the synchronization, or temporal alignment, of dubbed audio with the input sequence of images by controlling the speaking rate in automatic dubbing to improve the synchronization of the translated speech with the original utterance may have limited utility. For example, controlling the speaking rate in automatic dubbing based on linguistic content matching between source phrases and target, or dubbed, phrases by modelling the cross-lingual prosodic phrasing structure using the attention mechanism may be inaccurate for uneven or extreme speaking rates. In another example, controlling the speaking rate in automatic dubbing based on enhanced prosodic alignment based on speech fluency with respect to speaking rate variation and linguistic content matching, which may include using a time-boundary mechanism, and which includes breaking a sentence into segments and operating at the word level, may result in unnatural stops or gaps in the synthesized audio an may include intractable dynamic programming problems in view of the vast amount of variables.

The timing optimization for automatic video dubbing described herein improves on the synchronization, or temporal alignment, of dubbed audio with the input sequence of images by generating and synchronizing dubbed audio in accordance with formulating and solving an optimization problem that includes obtaining parameters for controlling audio synthesis speed and temporal start location on a per segment basis that is optimized for fluency, smoothness, duration matching, minimizing inter-segment speed variation and segment temporal drift. The timing optimization for automatic video dubbing described herein improves the efficiency of automatic dubbing by formulating the optimization problem as a diagonal optimization problem for large scale efficiency.

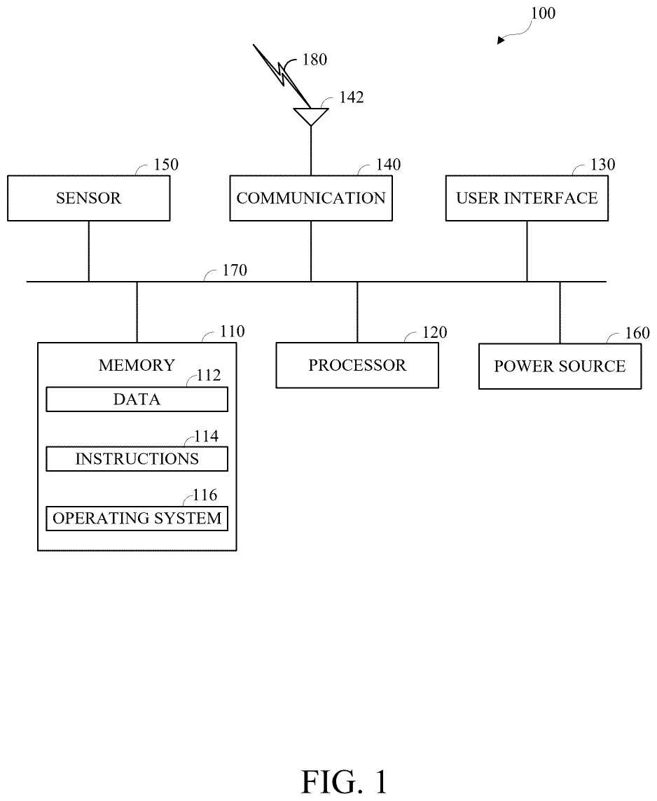

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

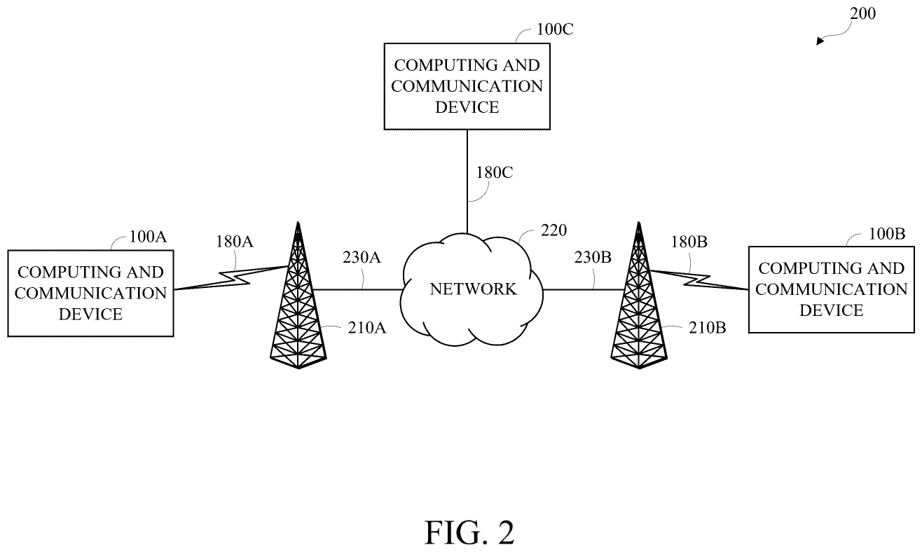

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

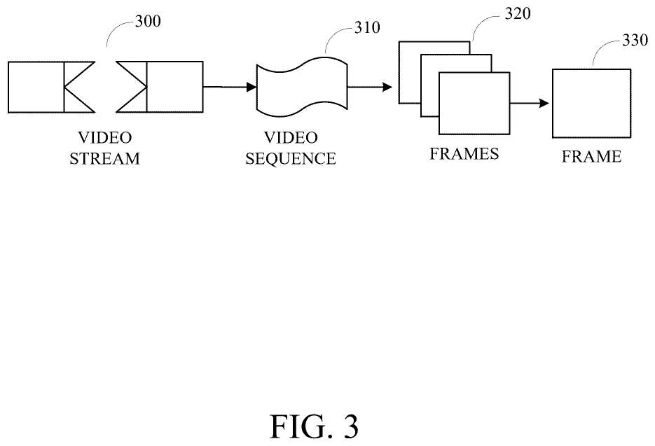

FIG. 3 is a diagram of a video stream 300 for use in timing optimization for automatic video dubbing in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320. Each frame 330 from the adjacent frames 320 may represent a single image from the video stream.

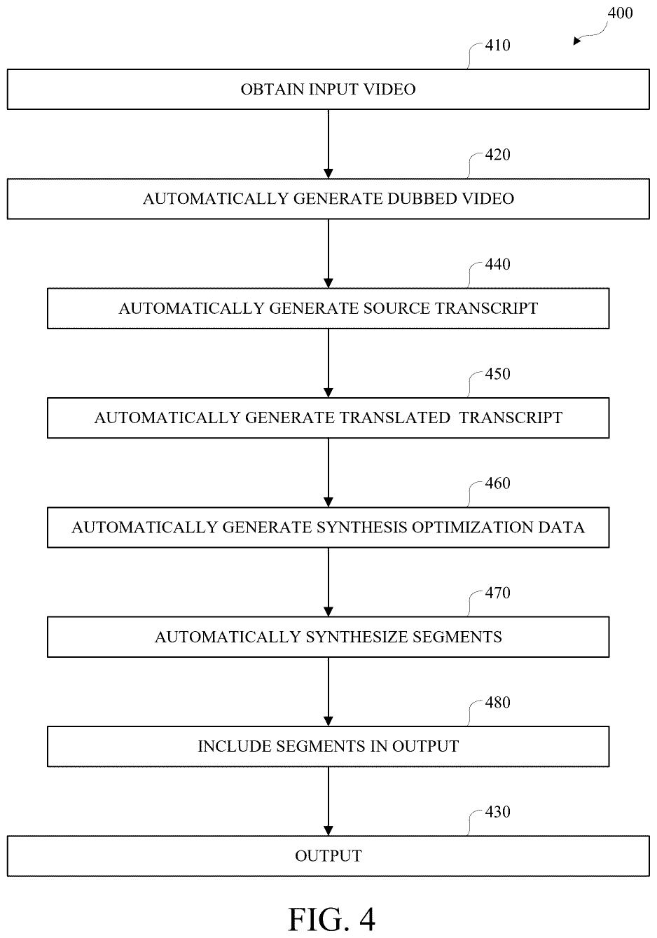

FIG. 4 is a flowchart diagram of an example of timing optimization for automatic video dubbing 400 in accordance with implementations of this disclosure. Timing optimization for automatic video dubbing 400 may be implemented a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to perform timing optimization for automatic video dubbing 400 as described herein. Timing optimization for automatic video dubbing 400 can be implemented as specialized hardware included, for example, in computing device 100.

Timing optimization for automatic video dubbing 400 includes obtaining an input video (at 410), automatically generating a dubbed video (at 420), and output (at 430).

Obtaining the input video (at 410) includes obtaining the input video including a sequence of input images and input audio synchronized with the sequence of input images. The input audio includes input speech audio in a first language and other audio, such as background sound. In some implementations, the first language may include multiple first languages.

Automatically generating a dubbed video (at 420) includes automatically generating the dubbed video comprising the sequence of input images, the other audio, and segments of automatically generated synthesized speech audio in a second language that differs from the first language. In some implementations, automatically generating the dubbed video (at 420) includes omitting or excluding the input speech audio from the dubbed video. In some implementations, automatically generating the dubbed video comprises including the segments of automatically generated synthesized speech audio in the input video as a distinct audio track.

Automatically generating the dubbed video (at 420) includes automatically generating a source transcript (at 440), automatically generating a translated transcript (at 450), automatically generating synthesis optimization data (at 460), automatically synthesizing the segments (at 470), and including the segments of automatically generated synthesized speech audio in the dubbed video (at 480).

Automatically generating the source transcript (at 440) includes automatically generating the source transcript of the input speech audio in the first language using a machine learning speech recognition model, such as an automatic speech recognition (ASR) model, to transcribe the input speech audio in the first language.

Automatically generating the source transcript (at 440) includes automatically segmenting the input speech audio into a sequence of input speech audio segments. A speech audio segment is a discrete portion of the speech audio, such as corresponding to a sentence. In some implementations, a speech audio segment may correspond to a portion of the speech audio that is greater than or less than a sentence. A text segment is a discrete portion of text, such as corresponding to a speech audio segment. For simplicity, the term ‘segment,’ as used herein, may refer to a speech audio segment, a text segment, or both.

Obtaining the source transcript may include obtaining source temporal data, such as temporal start location data, temporal end location data, or both, which may be relative to the input video, corresponding to respective segments of the input speech audio. In some implementations, obtaining the source transcript includes obtaining, on a per-segment basis, temporal start location data indicating a relative temporal location at which a respective segment begins with respect to the input video and temporal end location data indicating a relative temporal location at which the respective segment ends with respect to the input video. For example, a start or beginning, such as a sequentially first sample, of a sequentially first segment of the input speech audio may correspond with a sequentially first temporal start location relative to the input video, such as relative to a sequentially first frame of the input video.

Obtaining the source transcript may include obtaining data indicating a number, count, or cardinality of segments in the sequence of input speech audio segments or of the corresponding source transcript.

Automatically generating the translated transcript (at 450) includes automatically generating the translated transcript in the second language by translating the source transcript using a machine learning translation model, such as a neural machine translation (NMT) model, from the first language to the second language.

Automatically generating the translated transcript (at 450) includes obtaining translated transcript temporal data by automatically mapping the source temporal data for the source segments from the source transcript to corresponding translated segments in the translated transcript.

For example, a segment from the source transcript, may correspond with a temporal start location and a temporal end location, relative to the input video, and automatically generating the translated transcript (at 450) may include obtaining a translated transcript segment corresponding to the segment of the source transcript, associating the translated transcript segment with the temporal start location and associating the translated transcript segment with the temporal end location.

Automatically generating the translated transcript (at 450) may include obtaining data indicating a number, count, or cardinality of segments of translated speech in the translated transcript, such as corresponding to the cardinality of segments in source transcript.

For a respective segment of the source transcript the corresponding translated segment of the translated transcript may have different verbosity. Automatically generating the translated transcript (at 450) may include prioritizing translation quality over the spoken duration of the translation.

Automatically generating synthesis optimization data (at 460) includes automatically generating the synthesis optimization data for the segments of automatically generated synthesized speech audio in the second language.

Automatically generating synthesis optimization data (at 460) includes automatically generating the synthesis optimization data by solving a quadratic optimization problem formulated to synchronize the segments of automatically generated synthesized speech audio with the sequence of input images, such as for visual and auditory consistency. The quadratic optimization problem minimizes speed variations among the segments of automatically generated synthesized speech audio and drift, on a per-segment basis, of start temporal location, end temporal location, or both, of the segments of automatically generated synthesized speech audio relative to corresponding segments of the input speech audio.

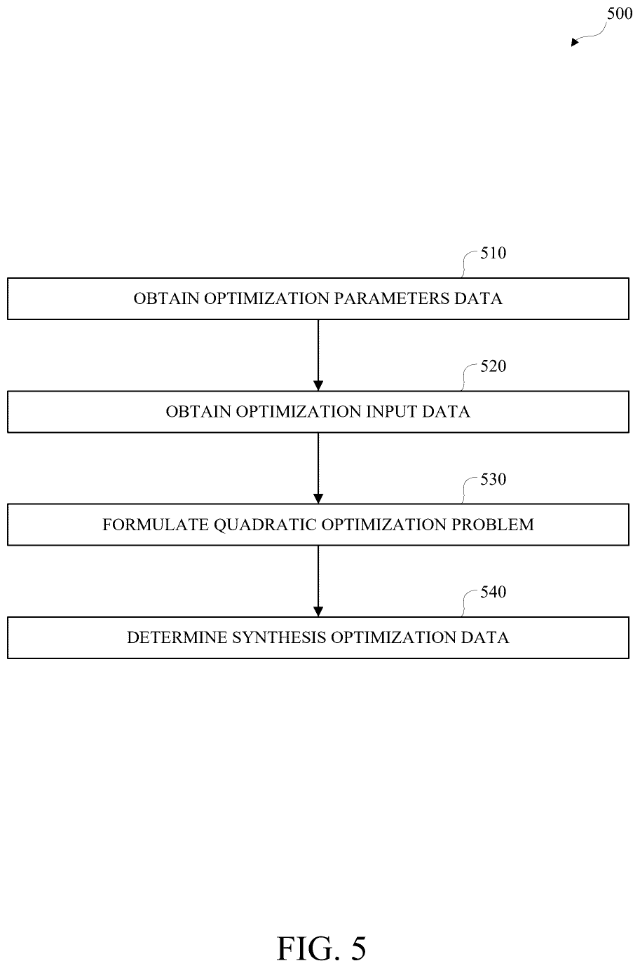

An example of automatically generating synthesis optimization data (at 460) is shown in FIG. 5.

Automatically synthesizing the segments (at 470) includes automatically synthesizing the segments of automatically generated synthesized speech audio in accordance with the synthesis optimization data and the translated transcript, such as using a machine learning text-to-speech (TTS) synthesis model.

For example, automatically generating synthesis optimization data (at 460) may include determining a value of a segment duration adjustment decision variable for a segment and automatically synthesizing the segments (at 470) may include synthesizing the segment of automatically generated synthesized speech audio in accordance with the value of the segment duration adjustment decision variable for the segment.

Including the segments of automatically generated synthesized speech audio in the dubbed video (at 480) in accordance with the synthesis optimization data.

For example, automatically generating synthesis optimization data (at 460) may include determining a value of a segment-start temporal location decision variable for a segment and including the segments of automatically generated synthesized speech audio in the dubbed video (at 480) may comprise including the segment of automatically generated synthesized speech audio for the segment in the dubbed video in accordance with the value of the segment-start temporal location decision variable for the segment.

Output (at 430) includes one or more of storing, transmitting, or outputting for presentation, the dubbed video.

FIG. 5 is a flowchart diagram of an example of automatically generating synthesis optimization data 500 in accordance with implementations of this disclosure. Automatically generating synthesis optimization data 500 may be implemented by a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to perform, or facilitate performance of, generating synthesis optimization data 500 as described herein. Automatically generating synthesis optimization data 500 can be implemented as specialized hardware included, for example, in computing device 100.

Automatically generating synthesis optimization data 500 includes automatically generating synthesis optimization data for the segments of automatically generated synthesized speech audio in the second language.

Automatically generating synthesis optimization data 500 includes obtaining optimization parameters data (at 510), obtaining optimization input data (at 520), formulating a quadratic optimization problem (at 530), and determining the synthesis optimization data (at 540).

Obtaining the optimization parameters data (at 510) includes obtaining the optimization parameters data for the quadratic optimization problem.

Obtaining the optimization parameters data (at 510) includes obtaining an objective term (x′ Qx).

Obtaining the objective term includes obtaining a defined positive semi-definite (PSD) matrix (Q, a defined positive semi-definite matrix).

Obtaining the objective term includes obtaining a vector of decision variables (x), such as on a per segment basis, such as for the segments of translated speech in the translated transcript, or, equivalently, for the segments of automatically generated synthesized speech audio corresponding to the segments of translated speech in the translated transcript.

For a respective segment (n), obtaining the vector of decision variables (x) comprises including, in the vector of decision variables (x), a segment-start temporal location decision variable (sₙ).

For a respective segment (n), obtaining the vector of decision variables (x) comprises including, in the vector of decision variables (x), a segment-end temporal location decision variable (eₙ).

For a respective segment (n), obtaining the vector of decision variables (x) comprises including, in the vector of decision variables (x), a segment duration adjustment decision variable (rₙ).

For a respective segment (n), obtaining the vector of decision variables (x) comprises including, in the vector of decision variables (x), a successive segments temporal duration adjustment difference decision variable (In).

For a respective segment (n), obtaining the vector of decision variables (x) comprises including, in the vector of decision variables (x), on a per pinned word basis for zero or more pinned words of the respective segment, a temporal pinned-word start location decision variable (pₘ).

Obtaining the objective term includes obtaining a transpose vector (x′) of the vector of decision variables (x).

In some implementations, obtaining the optimization parameters data (at 510) includes obtaining a defined minimum segment duration adjustment value (r^{low}), such as 1.0.

In some implementations, obtaining the optimization parameters data (at 510) includes obtaining a defined maximum segment duration adjustment value (r^{high}), such as 2.0.

Obtaining the optimization input data (at 520) includes obtaining a segments cardinality parameter (N) indicating the number, count, or cardinality of segments of translated speech in the translated transcript, or, equivalently, for the segments of automatically generated synthesized speech audio corresponding to the segments of translated speech in the translated transcript.

Obtaining the optimization input data (at 520) includes obtaining, on a per-segment basis for the segments of translated speech, wherein n is a segment index value, or segment identifier, of a segment in the segments of translated speech (n ∈ {0, 1, . . . , N−1}), a target segment-start temporal location (Sₙ). The target segment-start temporal location (Sₙ) for a segment (n) is, or corresponds to, the temporal start location associated with the corresponding segment from the translated transcript. The target segment-start temporal location (Sₙ) for a segment (n) may be referred to herein as an anchor location for the segment (n).

Obtaining the optimization input data (at 520) includes obtaining, on a per segment basis for the segments of translated speech, a target segment-end temporal location (Eₙ). The target segment-end temporal location (Eₙ) for a segment (n) is, or corresponds to, the temporal end location associated with the corresponding segment from the translated transcript. The target segment-end temporal location (Eₙ) for a segment (n) may be referred to herein as an anchor location for the segment (n).

Obtaining the optimization input data includes obtaining, on a per segment basis for the segments of translated speech, a target segment duration adjustment value (Rₙ). The target segment duration adjustment value (Rₙ) is an inverse of a speed multiplier for the respective segment (n).

Obtaining the optimization input data (at 520) includes obtaining, on a per segment basis for the segments of translated speech, an unadjusted temporal segment duration value (Dₙ) corresponding to synthesizing the respective segment (n) in accordance with a speed multiplier of one (1.0).

Obtaining the optimization input data (at 520) includes obtaining, on a per segment basis for the segments of translated speech, a number, count, or cardinality of pinned words (M).

Obtaining the optimization input data (at 520) includes obtaining, on a per segment basis for the segments of translated speech, and for zero or more pinned words of a respective segment, on a per pinned word basis, obtaining a target temporal pinned-word start location (Pₘ), wherein m is a pinned word index value, or pinned word identifier, of a pinned word in a respective segment (n) of translated speech (m ∈ {0, 1, . . . , M−1}),

Obtaining the optimization input data (at 520) includes obtaining, on a per segment basis for the segments of translated speech, and for zero or more pinned words of a respective segment, on a per pinned word basis, obtaining an unadjusted temporal pinned-word location offset (Oₘ) with respect to the target segment-start temporal location (Sₙ) corresponding to synthesizing the respective pinned word in accordance with a speed multiplier of one (1.0).

Formulating the quadratic optimization problem (at 530) includes formulating the quadratic optimization problem in accordance with the optimization parameters data and the optimization input data.

Formulating the quadratic optimization problem (at 530) includes formulating objective functions for the quadratic optimization problem.

Formulating the objective functions includes formulating a per-segment start drift objective function indicating minimizing, for the segments of translated speech in the translated transcript, or, equivalently, for the segments of automatically generated synthesized speech audio corresponding to the segments of translated speech in the translated transcript, a sum of first squared differences, wherein the first squared differences include, for the respective segment, a square of a result of subtracting the target segment-start temporal location (Sₙ) for the respective segment from the value of the segment-start temporal location decision variable (sₙ) for the respective segment, which may be expressed as the following:

$$min {\sum }_{n = 0}^{N - 1} {( {s}_{n} - {S}_{n} )}^{2} .$$

Formulating the objective functions includes formulating a per-segment end drift objective function indicating minimizing, for the segments of translated speech in the translated transcript, or, equivalently, for the segments of automatically generated synthesized speech audio corresponding to the segments of translated speech in the translated transcript, a sum of second squared differences, wherein the second squared differences include, for the respective segment, a square of a result of subtracting the target segment-end temporal location (Eₙ) for the respective segment from the value of the segment-end temporal location decision variable (eₙ) for the respective segment, which may be expressed as the following:

$$min {\sum }_{n = 0}^{N - 1} {( {e}_{n} - {E}_{n} )}^{2} .$$

Formulating the objective functions includes formulating a speed drift objective function indicating minimizing, for the segments of translated speech in the translated transcript, or, equivalently, for the segments of automatically generated synthesized speech audio corresponding to the segments of translated speech in the translated transcript, a sum of squared values of the successive segments temporal duration adjustment difference decision variable (vₙ), wherein, for the respective segment, the sum of the values of the squared successive segments temporal duration adjustment difference decision variable (vₙ) includes a square of the value of the successive segments temporal duration adjustment difference decision variable for the respective segment, which may be expressed as the following:

$$min {\sum }_{n = 0}^{N - 1} {v}_{n}^{2} .$$

Formulating the objective functions includes formulating an anchor speed drift objective function indicating minimizing, for the segments of translated speech in the translated transcript, or, equivalently, for the segments of automatically generated synthesized speech audio corresponding to the segments of translated speech in the translated transcript, a sum of third squared differences, wherein the third squared differences include, for the respective segment, a square of a result of subtracting the target segment duration adjustment value (Rₙ) for the respective segment from the value of the segment duration adjustment decision variable (rₙ) for the respective segment, which may be expressed as the following:

$$min {\sum }_{n = 0}^{N - 1} {( {r}_{n} - {R}_{n} )}^{2} .$$

Formulating the objective functions includes formulating a pinned word drift objective function indicating minimizing, for the zero or more pinned words of the segments of translated speech in the translated transcript, or, equivalently, for the segments of automatically generated synthesized speech audio corresponding to the segments of translated speech in the translated transcript, a sum of fourth squared differences, wherein the fourth squared differences include, for a respective pinned word, a square of a result of subtracting the target temporal pinned-word start location (Pₘ) for the respective pinned word from the value of the temporal pinned-word start location decision variable (pₘ) for the respective pinned word, which may be expressed as the following:

$$min {\sum }_{m = 0}^{M - 1} {( {p}_{m} - {P}_{m} )}^{2} .$$

Formulating the quadratic optimization problem (at 530) includes formulating constraints for the quadratic optimization problem.

Formulating the constraints for the quadratic optimization problem includes formulating a cumulative temporal duration constraint.

In some implementations, the cumulative temporal duration constraint indicates that a sum of adjusted segment durations for the segments of translated speech in the translated transcript is less than or equal to a duration of the input audio (audio track length), wherein, for a respective segment from the segments of translated speech in the translated transcript, such as from a sequentially first segment (n=0) to a sequentially last segment (N−1), an adjusted segment duration is a product of multiplying a value of the segment duration adjustment decision variable (rₙ) for the respective segment and the unadjusted temporal segment duration value (Dₙ) of the respective segment, which may be expressed as the following:

$${\sum }_{n = 0}^{N - 1} {r}_{n} {D}_{n} \leq audio track length .$$

In some implementations, the cumulative temporal duration constraint equivalently indicates that a value (s₀) of the segment-start temporal location decision variable (sₙ) for the sequentially first segment (n=0) is greater than or equal to zero (0), which may be expressed as s₀≥0, and a value (e_{N-1}) of the segment-end temporal location decision variable (eₙ) for the sequentially last segment (N−1) is less than or equal to the input audio (audio track length), which may be expressed as e_{N-1}≤audio track length.

Formulating the constraints for the quadratic optimization problem includes formulating constraints on a per segment basis for the segments of translated speech in the translated transcript, or, equivalently, for the segments of automatically generated synthesized speech audio corresponding to the segments of translated speech in the translated transcript.

For a respective segment from the segments of translated speech in the translated transcript, or, equivalently, a respective segment of the segments of automatically generated synthesized speech audio corresponding to the segments of translated speech in the translated transcript, formulating the constraints includes formulating a segment overlap constraint indicating that a sum of the value of the segment-end temporal location decision variable (eₙ) for the respective segment and a defined inter-segment temporal duration (buffer) is less than or equal to a value of the segment-start temporal location decision variable (sₙ₊₁) of a sequentially subsequent segment (n+1), which may be expressed as the following:

eₙ+(buffer)≤sₙ₊₁.

For a respective segment from the segments of translated speech in the translated transcript, or, equivalently, a respective segment of the segments of automatically generated synthesized speech audio corresponding to the segments of translated speech in the translated transcript, formulating the constraints includes formulating a duration adjustment constraint indicating that a value of the segment duration adjustment decision variable (rₙ) for the respective segment is greater than or equal to the defined minimum segment duration adjustment value (r^{low}) and is less than or equal to the defined maximum segment duration adjustment value (r^{high}), which may be expressed as the following:

r^{low}≤rₙ≤r^{high}.

For a respective segment from the segments of translated speech in the translated transcript, or, equivalently, a respective segment of the segments of automatically generated synthesized speech audio corresponding to the segments of translated speech in the translated transcript, formulating the constraints includes formulating a temporal continuity constraint indicating that the value of the segment-end temporal location decision variable (eₙ) for the respective segment matches a sum of a value of the segment-start temporal location decision variable (sₙ) for the respective segment and the product of multiplying the value of the segment duration adjustment decision variable (rₙ) for the respective segment and the unadjusted temporal segment duration value (Dₙ) of the respective segment, which may be expressed as the following:

eₙ=sₙ+rₙDₙ.

For a respective segment from the segments of translated speech in the translated transcript, or, equivalently, a respective segment of the segments of automatically generated synthesized speech audio corresponding to the segments of translated speech in the translated transcript, formulating the constraints includes formulating a speed variation constraint indicating that a value of the successive segments temporal duration adjustment difference decision variable (vₙ) for the respective segment matches a result of subtracting the value of the segment duration adjustment decision variable (rₙ) for the respective segment from a value of the segment duration adjustment decision variable (rₙ₊₁) of a sequentially subsequent segment (n+1) from the segments of translated speech in the translated transcript, which may be expressed as the following:

vₙ=rₙ₊₁−rₙ.

For a respective segment from the segments of translated speech in the translated transcript, or, equivalently, a respective segment of the segments of automatically generated synthesized speech audio corresponding to the segments of translated speech in the translated transcript, formulating the constraints includes formulating a pinned temporal location constraint indicating that, on a per pinned word basis for the zero or more pinned words of the respective segment, a value of the temporal pinned-word start location decision variable (pₘ) of a respective pinned word matches a sum of the value of the segment-start temporal location decision variable (sₙ) of the respective segment and a product of the value of the segment duration adjustment decision variable (rₙ) of the respective segment and the unadjusted temporal pinned-word location offset (Oₘ) of the respective pinned word, which may be expressed as the following:

pₘ=sₙ+rₙOₘ.

In some implementations, formulating the quadratic optimization problem (at 530) includes formulating the quadratic optimization problem to minimize a sum of mathematical elements, in accordance with a first penalty value (α), a second penalty value (β), and a third penalty value (γ), such that the constraints are satisfied.

The mathematical elements include a sum, with respect to the segments of translated speech in the translated transcript, or, equivalently, a respective segment of the segments of automatically generated synthesized speech audio corresponding to the segments of translated speech in the translated transcript, of first result values. For a respective segment, the first result values include a result of subtracting a product of multiplying the first penalty value (α) by a product of multiplying a product of multiplying two (2) by the target segment-start temporal location (Sₙ) for the respective segment by the value of the segment-start temporal location decision variable (sₙ) for the respective segment from a product of multiplying the first penalty value (α) by a square of the value of the segment-start temporal location decision variable (sₙ) for the respective segment, which may be expressed as the following:

$${\sum }_{n} α {s}_{n}^{2} - α 2 {S}_{n} {s}_{n} .$$

The mathematical elements include a sum, with respect to the segments of translated speech in the translated transcript, or, equivalently, a respective segment of the segments of automatically generated synthesized speech audio corresponding to the segments of translated speech in the translated transcript, of second result values. For the respective segment, the second result values include a result of subtracting a product of multiplying the first penalty value (α) by a product of multiplying a product of multiplying two (2) by the target segment-end temporal location (Eₙ) for the respective segment by the value of the segment-end temporal location decision variable (eₙ) for the respective segment from a product of multiplying the first penalty value (α) by a square of the value of the segment-end temporal location decision variable (eₙ) for the respective segment, which may be expressed as the following:

$${\sum }_{n} α {e}_{n}^{2} - α 2 {E}_{n} {e}_{n} .$$

The mathematical elements include a sum, with respect to the segments of translated speech in the translated transcript, or, equivalently, a respective segment of the segments of automatically generated synthesized speech audio corresponding to the segments of translated speech in the translated transcript, of third result values. For the respective segment, the third result values include a product of multiplying the second penalty value (β) by a square of the value of the successive segments temporal duration adjustment difference decision variable (vₙ) for the respective segment, which may be expressed as the following:

$${\sum }_{n} β {v}_{n}^{2} .$$

The mathematical elements include a sum, with respect to the segments of translated speech in the translated transcript, or, equivalently, a respective segment of the segments of automatically generated synthesized speech audio corresponding to the segments of translated speech in the translated transcript, of fourth result values. For the respective segment, the fourth result values include a result of subtracting a product of multiplying the second penalty value (β) by a product of multiplying a product of multiplying two (2) by the target segment duration adjustment value (Rₙ) for the respective segment by the value of the segment duration adjustment decision variable (rₙ) for the respective segment from a product of multiplying the second penalty value (β) by a square of the value of the segment duration adjustment decision variable (rₙ) for the respective segment, which may be expressed as the following:

$${\sum }_{n} β {r}_{n}^{2} - β 2 {R}_{n} {r}_{n} .$$

The mathematical elements include a sum, with respect to the zero or more pinned words of the segments of translated speech in the translated transcript, or, equivalently, a respective segment of the segments of automatically generated synthesized speech audio corresponding to the segments of translated speech in the translated transcript, of fifth result values. For a respective pinned word, the fifth result values include a result of subtracting a product of multiplying the third penalty value (γ) by a product of multiplying a product of multiplying two (2) by the target temporal pinned-word start location (pₘ) for the respective pinned word by the value of the temporal pinned-word start location decision variable (pₘ) for the respective pinned word from a product of multiplying the third penalty value (γ) by a square of the value of the temporal pinned-word start location decision variable (pₘ) for the respective pinned word, which may be expressed as the following:

$${\sum }_{m}^{M} γ {p}_{m}^{2} - 2 γ {P}_{m} {p}_{m} .$$

Minimizing the sum of the mathematical elements may be expressed as the following:

$$min {\sum }_{n} α {s}_{n}^{2} - α2 {S}_{n} {s}_{n}$$

$$+ {\sum }_{n} α {e}_{n}^{2} - α2 {E}_{n} {e}_{n}$$

$$+ {\sum }_{n} β {v}_{n}^{2}$$

$$+ {\sum }_{n} β {r}_{n}^{2} - β2 {R}_{n} {r}_{n}$$

$$+ {\sum }_{m}^{M} γ {p}_{m}^{2} - 2 γ {P}_{m} {p}_{m} .$$

In some implementations, formulating the quadratic optimization problem (at 530) includes reformulating the quadratic optimization problem as a diagonal optimization problem, such that elements of the defined positive semi-definite matrix (Q), other than elements along a main diagonal thereof (i=j), are zero value elements and the of the defined positive semi-definite matrix (Q) along the main diagonal may be non-zero.

Determining the synthesis optimization data (at 540) includes determining the synthesis optimization data by solving the quadratic optimization problem.

Solving the quadratic optimization problem includes, for a respective segment from the segments of automatically generated synthesized speech audio, determining values of the decision variables.

For a respective segment (n) from the segments of automatically generated synthesized speech audio, determining values of the decision variables (x) includes determining a value of the segment-start temporal location decision variable (sₙ).

For a respective segment (n) from the segments of automatically generated synthesized speech audio, determining values of the decision variables (x) includes determining a value of the segment-end temporal location decision variable (eₙ).

For a respective segment (n) from the segments of automatically generated synthesized speech audio, determining values of the decision variables (x) includes determining a value of the segment duration adjustment decision variable (rₙ).

For a respective segment (n) from the segments of automatically generated synthesized speech audio, determining values of the decision variables (x) includes determining a value of the successive segments temporal duration adjustment difference decision variable (vₙ).

For a respective segment (n) from the segments of automatically generated synthesized speech audio, determining values of the decision variables (x) includes determining, on a per pinned word basis for zero or more pinned words of the respective segment, a value of the temporal pinned-word start location decision variable (pₘ). In some implementations, determining the values of the temporal pinned-word start location decision variable (pₘ) may be omitted, skipped, excluded, or avoided.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted, avoided, or excluded from implementations of methods in accordance with the disclosed subject matter.

The implementations of the computing and communication device 100A and/or the computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the computing and communication device 100A and the computing and communication device 100B do not necessarily have to be implemented in the same manner.

Further, in one implementation, for example, the computing and communication device 100A or the computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The computing and communication device 100A and computing and communication device 100B can, for example, be implemented on computers in a real-time video system. Alternatively, the computing and communication device 100A can be implemented on a server and the computing and communication device 100B can be implemented on a device separate from the server, such as a hand-held communications device. Other suitable computing and communication device 100A and computing and communication device 100B implementation schemes are available.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method for automatic video dubbing, the method comprising:
obtaining an input video comprising:
a sequence of input images; and
input audio, wherein the input audio includes:
input speech audio in a first language; and
other audio;
automatically generating a dubbed video comprising the sequence of input images, the other audio, and segments of automatically generated synthesized speech audio in a second language, wherein automatically generating the dubbed video includes:
automatically generating a source transcript of the input speech audio in the first language using a machine learning speech recognition model;
automatically generating a translated transcript in the second language by translating the source transcript using a machine learning translation model;
automatically generating synthesis optimization data by solving a quadratic optimization problem formulated to synchronize the segments of automatically generated synthesized speech audio with the sequence of input images;
automatically synthesizing the segments of automatically generated synthesized speech audio in accordance with the synthesis optimization data and the translated transcript using a machine learning text-to-speech synthesis model; and
including the segments of automatically generated synthesized speech audio in the dubbed video in accordance with the synthesis optimization data; and
outputting the dubbed video.

2. The method of claim 1, wherein automatically generating the synthesis optimization data includes:
obtaining optimization parameters data for a quadratic optimization problem, the optimization parameters data including:
an objective term, wherein the objective term includes:
a defined positive semi-definite matrix; and
a vector of decision variables;
a defined minimum segment duration adjustment value; and
a defined maximum segment duration adjustment value;
obtaining optimization input data including:
a segments cardinality parameter indicating a cardinality of segments of translated speech in the translated transcript; and
on a per segment basis for the segments of translated speech in the translated transcript:
a target segment-start temporal location;
a target segment-end temporal location;
a target segment duration adjustment value;
an unadjusted temporal segment duration value; and
a cardinality of pinned words, wherein, for the pinned words, on a per pinned word basis, the optimization input data includes:
a target temporal pinned-word start location; and
an unadjusted temporal pinned-word location offset with respect to
the target segment-start temporal location;
formulating the quadratic optimization problem in accordance with the optimization parameters data and the optimization input data, wherein formulating the quadratic optimization problem includes formulating:
objective functions for the quadratic optimization problem; and
constraints for the quadratic optimization problem; and
determining the synthesis optimization data by solving the quadratic optimization problem, wherein solving the quadratic optimization problem includes, for a respective segment from the segments of automatically generated synthesized speech audio, determining values of the decision variables.

3. The method of claim 2, wherein obtaining the optimization parameters data includes obtaining the vector of decision variables on a per segment basis for the segments of automatically generated synthesized speech audio, wherein, for a respective segment of the segments of automatically generated synthesized speech audio, obtaining the vector of decision variables comprises including, in the vector of decision variables:
a segment-start temporal location decision variable;
a segment-end temporal location decision variable;
a segment duration adjustment decision variable;
a successive segments temporal duration adjustment difference decision variable; and
on a per pinned word basis for zero or more pinned words of the respective segment, a temporal pinned-word start location decision variable.

4. The method of claim 3, formulating the constraints includes formulating:
a cumulative temporal duration constraint indicating that a sum of adjusted segment durations for the segments of translated speech in the translated transcript is less than or equal to a duration of the input audio, wherein, for a respective segment from the segments of translated speech in the translated transcript, an adjusted segment duration is a product of multiplying a value of the segment duration adjustment decision variable for the respective segment and the unadjusted temporal segment duration value of the respective segment.

5. The method of claim 4, formulating the constraints includes formulating constraints on a per segment basis for the segments of translated speech in the translated transcript, wherein, for a respective segment from the segments of translated speech in the translated transcript, formulating the constraints includes formulating:
a segment overlap constraint indicating that a sum of a value of the segment-end temporal location decision variable for the respective segment and a defined inter-segment temporal duration is less than or equal to a value of a segment-start temporal location decision variable of a sequentially subsequent segment from the segments of translated speech in the translated transcript;
a duration adjustment constraint indicating that the value of the segment duration adjustment decision variable for the respective segment is greater than or equal to the defined minimum segment duration adjustment value and is less than or equal to the defined maximum segment duration adjustment value;
a temporal continuity constraint indicating that the value of the segment-end temporal location decision variable for the respective segment matches a sum of a value of the segment-start temporal location decision variable for the respective segment and the product of multiplying the value of the segment duration adjustment decision variable for the respective segment and the unadjusted temporal segment duration value of the respective segment;
a speed variation constraint indicating that a value of the successive segments temporal duration adjustment difference decision variable for the respective segment matches a result of subtracting the value of the segment duration adjustment decision variable for the respective segment from a value of the segment duration adjustment decision variable of a sequentially subsequent segment from the segments of translated speech in the translated transcript; and
a pinned temporal location constraint indicating that, on a per pinned word basis for the zero or more pinned words of the respective segment, a value of the temporal pinned-word start location decision variable of a respective pinned word matches a sum of the value of the segment-start temporal location decision variable of the respective segment and a product of the value of the segment duration adjustment decision variable of the respective segment and the unadjusted temporal pinned-word location offset of the respective pinned word.

6. The method of claim 3, wherein formulating the objective functions includes formulating:
a per-segment start drift objective function indicating minimizing, for the segments of translated speech in the translated transcript, a sum of first squared differences, wherein the first squared differences include, for the respective segment, a square of a result of subtracting the target segment-start temporal location for the respective segment from a value of the segment-start temporal location decision variable for the respective segment;
a per-segment end drift objective function indicating minimizing, for the segments of translated speech in the translated transcript, a sum of second squared differences, wherein the second squared differences include, for the respective segment, a square of a result of subtracting the target segment-end temporal location for the respective segment from a value of the segment-end temporal location decision variable for the respective segment;
a speed drift objective function indicating minimizing, for the segments of translated speech in the translated transcript, a sum of squared values of the successive segments temporal duration adjustment difference decision variable, wherein, for the respective segment, the sum of squared values of the successive segments temporal duration adjustment difference decision variable includes a square of a value of the successive segments temporal duration adjustment difference decision variable for the respective segment;
an anchor speed drift objective function indicating minimizing, for the segments of translated speech in the translated transcript, a sum of third squared differences, wherein the third squared differences include, for the respective segment, a square of a result of subtracting the target segment duration adjustment value for the respective segment from a value of the segment duration adjustment decision variable for the respective segment; and
a pinned word drift objective function indicating minimizing, for the zero or more pinned words of the segments of translated speech in the translated transcript, a sum of fourth squared differences, wherein the fourth squared differences include, for a respective pinned word, a square of a result of subtracting the target temporal pinned-word start location for the respective pinned word from a value of the temporal pinned-word start location decision variable for the respective pinned word.

7. The method of claim 3, wherein formulating the quadratic optimization problem includes formulating the quadratic optimization problem to:
minimize a sum of:
a sum, with respect to the segments of translated speech in the translated transcript, of first result values, wherein, for a respective segment from the segments of translated speech in the translated transcript, the first result values include a result of subtracting a product of multiplying a first penalty value by a product of multiplying a product of multiplying two by the target segment-start temporal location for the respective segment by a value of the segment-start temporal location decision variable for the respective segment from a product of multiplying the first penalty value by a square of the value of the segment-start temporal location decision variable for the respective segment;
a sum, with respect to the segments of translated speech in the translated transcript, of second result values, wherein, for the respective segment, the second result values include a result of subtracting a product of multiplying the first penalty value by a product of multiplying a product of multiplying two by the target segment-end temporal location for the respective segment by a value of the segment-end temporal location decision variable for the respective segment from a product of multiplying the first penalty value by a square of the value of the segment-end temporal location decision variable for the respective segment;
a sum, with respect to the segments of translated speech in the translated transcript, of third result values, wherein, for the respective segment, the third result values include a product of multiplying a second penalty value by a square of the value of the successive segments temporal duration adjustment difference decision variable for the respective segment;
a sum, with respect to the segments of translated speech in the translated transcript, of fourth result values, wherein, for the respective segment, the fourth result values include a result of subtracting a product of multiplying the second penalty value by a product of multiplying a product of multiplying two by the target segment duration adjustment value for the respective segment by a value of the segment duration adjustment decision variable for the respective segment from a product of multiplying the second penalty value by a square of the value of the segment duration adjustment decision variable for the respective segment; and
a sum, with respect to the zero or more pinned words of the segments of translated speech in the translated transcript, of fifth result values, wherein, for a respective pinned word, the fifth result values include a result of subtracting a product of multiplying a third penalty value by a product of multiplying a product of multiplying two by the target temporal pinned-word start location for the respective pinned word by a value of the temporal pinned-word start location decision variable for the respective pinned word from a product of multiplying the third penalty value by a square of the value of the temporal pinned-word start location decision variable for the respective pinned word;
such that the constraints are satisfied.

8. The method of claim 2, wherein formulating the quadratic optimization problem includes reformulating the quadratic optimization problem as a diagonal optimization problem.

9. An apparatus for automatic video dubbing, the apparatus comprising:
a non-transitory computer-readable medium; and
a processor configured to execute instructions stored on the non-transitory computer-readable medium to:
obtain an input video comprising:
a sequence of input images; and
input audio, wherein the input audio includes:
input speech audio in a first language; and
other audio;
automatically generate a dubbed video comprising the sequence of input images, the other audio, and segments of automatically generated synthesized speech audio in a second language, wherein, to automatically generate the dubbed video, the processor is configured to execute the instructions to:
automatically generate a source transcript of the input speech audio in the first language, wherein, to automatically generate the source transcript, the processor is configured to execute the instructions to use a machine learning speech recognition model;
automatically generate a translated transcript in the second language by translating the source transcript, wherein, to automatically generate the translated transcript, the processor is configured to execute the instructions to use a machine learning translation model;
automatically generate synthesis optimization data, wherein, to automatically generate the synthesis optimization data, the processor is configured to execute the instructions to solve a quadratic optimization problem formulated to synchronize the segments of automatically generated synthesized speech audio with the sequence of input images;
automatically synthesize the segments of automatically generated synthesized speech audio in accordance with the synthesis optimization data and the translated transcript, wherein, to automatically synthesize the segments of automatically generated synthesized speech audio, the processor is configured to execute the instructions to use a machine learning text-to-speech synthesis model; and
include the segments of automatically generated synthesized speech audio in the dubbed video in accordance with the synthesis optimization data; and
output the dubbed video.

10. The apparatus of claim 9, wherein, to automatically generate the synthesis optimization data, the processor is configured to execute the instructions to:
obtain optimization parameters data for a quadratic optimization problem, the optimization parameters data including:
an objective term, wherein the objective term includes:
a defined positive semi-definite matrix; and
a vector of decision variables;
a defined minimum segment duration adjustment value; and
a defined maximum segment duration adjustment value;
obtain optimization input data including:
a segments cardinality parameter indicating a cardinality of segments of translated speech in the translated transcript; and
on a per segment basis for the segments of translated speech in the translated transcript:
a target segment-start temporal location;
a target segment-end temporal location;
a target segment duration adjustment value;
an unadjusted temporal segment duration value; and
a cardinality of pinned words, wherein, for the pinned words, on a per pinned word basis, the optimization input data includes:
a target temporal pinned-word start location; and
an unadjusted temporal pinned-word location offset with respect to the target segment-start temporal location;
formulate the quadratic optimization problem in accordance with the optimization parameters data and the optimization input data, wherein, to formulate the quadratic optimization problem, the processor is configured to execute the instructions to formulate:
objective functions for the quadratic optimization problem; and
constraints for the quadratic optimization problem; and
determine the synthesis optimization data, wherein, to determine the synthesis optimization data, the processor is configured to execute the instructions to solve the quadratic optimization problem, wherein, to solve the quadratic optimization problem, the processor is configured to execute the instructions to, for a respective segment from the segments of automatically generated synthesized speech audio, determine values of the decision variables.

11. The apparatus of claim 10, wherein, to obtain the optimization parameters data, the processor is configured to execute the instructions to obtain the vector of decision variables on a per segment basis for the segments of automatically generated synthesized speech audio, wherein, for a respective segment of the segments of automatically generated synthesized speech audio, to obtain the vector of decision variables, the processor is configured to execute the instructions to include, in the vector of decision variables:
a segment-start temporal location decision variable;
a segment-end temporal location decision variable;
a segment duration adjustment decision variable;
a successive segments temporal duration adjustment difference decision variable; and
on a per pinned word basis for zero or more pinned words of the respective segment, a temporal pinned-word start location decision variable.

12. The apparatus of claim 11, wherein to formulate the constraints, the processor is configured to execute the instructions to:
formulate a cumulative temporal duration constraint indicating that a sum of adjusted segment durations for the segments of translated speech in the translated transcript is less than or equal to a duration of the input audio, wherein, for a respective segment from the segments of translated speech in the translated transcript, an adjusted segment duration is a product of multiplying a value of the segment duration adjustment decision variable for the respective segment and the unadjusted temporal segment duration value of the respective segment; and
formulate constraints on a per segment basis for the segments of translated speech in the translated transcript, wherein, for a respective segment from the segments of translated speech in the translated transcript, to formulate the constraints, the processor is configured to execute the instructions to formulate:
a segment overlap constraint indicating that a sum of a value of the segment-end temporal location decision variable for the respective segment and a defined inter-segment temporal duration is less than or equal to a value of a segment-start temporal location decision variable of a sequentially subsequent segment from the segments of translated speech in the translated transcript;
a duration adjustment constraint indicating that the value of the segment duration adjustment decision variable for the respective segment is greater than or equal to the defined minimum segment duration adjustment value and is less than or equal to the defined maximum segment duration adjustment value;
a temporal continuity constraint indicating that the value of the segment-end temporal location decision variable for the respective segment matches a sum of a value of the segment-start temporal location decision variable for the respective segment and the product of multiplying the value of the segment duration adjustment decision variable for the respective segment and the unadjusted temporal segment duration value of the respective segment;
a speed variation constraint indicating that a value of the successive segments temporal duration adjustment difference decision variable for the respective segment matches a result of subtracting the value of the segment duration adjustment decision variable for the respective segment from a value of the segment duration adjustment decision variable of a sequentially subsequent segment from the segments of translated speech in the translated transcript; and
a pinned temporal location constraint indicating that, on a per pinned word basis for the zero or more pinned words of the respective segment, a value of the temporal pinned-word start location decision variable of a respective pinned word matches a sum of the value of the segment-start temporal location decision variable of the respective segment and a product of the value of the segment duration adjustment decision variable of the respective segment and the unadjusted temporal pinned-word location offset of the respective pinned word.

13. The apparatus of claim 11, wherein, to formulate the objective functions, the processor is configured to execute the instructions to formulate:
a per-segment start drift objective function indicating minimizing, for the segments of translated speech in the translated transcript, a sum of first squared differences, wherein the first squared differences include, for the respective segment, a square of a result of subtracting the target segment-start temporal location for the respective segment from a value of the segment-start temporal location decision variable for the respective segment;
a per-segment end drift objective function indicating minimizing, for the segments of translated speech in the translated transcript, a sum of second squared differences, wherein the second squared differences include, for the respective segment, a square of a result of subtracting the target segment-end temporal location for the respective segment from a value of the segment-end temporal location decision variable for the respective segment;
a speed drift objective function indicating minimizing, for the segments of translated speech in the translated transcript, a sum of squared values of the successive segments temporal duration adjustment difference decision variable, wherein, for the respective segment, the sum of squared values of the successive segments temporal duration adjustment difference decision variable includes a square of a value of the successive segments temporal duration adjustment difference decision variable for the respective segment;
an anchor speed drift objective function indicating minimizing, for the segments of translated speech in the translated transcript, a sum of third squared differences, wherein the third squared differences include, for the respective segment, a square of a result of subtracting the target segment duration adjustment value for the respective segment from a value of the segment duration adjustment decision variable for the respective segment; and
a pinned word drift objective function indicating minimizing, for the zero or more pinned words of the segments of translated speech in the translated transcript, a sum of fourth squared differences, wherein the fourth squared differences include, for a respective pinned word, a square of a result of subtracting the target temporal pinned-word start location for the respective pinned word from a value of the temporal pinned-word start location decision variable for the respective pinned word.

14. The apparatus of claim 11, wherein, to formulate the quadratic optimization problem, the processor is configured to execute the instructions to formulate the quadratic optimization problem to:
minimize a sum of:
a sum, with respect to the segments of translated speech in the translated transcript, of first result values, wherein, for a respective segment from the segments of translated speech in the translated transcript, the first result values include a result of subtracting a product of multiplying a first penalty value by a product of multiplying a product of multiplying two by the target segment-start temporal location for the respective segment by a value of the segment-start temporal location decision variable for the respective segment from a product of multiplying the first penalty value by a square of the value of the segment-start temporal location decision variable for the respective segment;
a sum, with respect to the segments of translated speech in the translated transcript, of second result values, wherein, for the respective segment, the second result values include a result of subtracting a product of multiplying the first penalty value by a product of multiplying a product of multiplying two by the target segment-end temporal location for the respective segment by a value of the segment-end temporal location decision variable for the respective segment from a product of multiplying the first penalty value by a square of the value of the segment-end temporal location decision variable for the respective segment;
a sum, with respect to the segments of translated speech in the translated transcript, of third result values, wherein, for the respective segment, the third result values include a product of multiplying a second penalty value by a square of the value of the successive segments temporal duration adjustment difference decision variable for the respective segment;
a sum, with respect to the segments of translated speech in the translated transcript, of fourth result values, wherein, for the respective segment, the fourth result values include a result of subtracting a product of multiplying the second penalty value by a product of multiplying a product of multiplying two by the target segment duration adjustment value for the respective segment by a value of the segment duration adjustment decision variable for the respective segment from a product of multiplying the second penalty value by a square of the value of the segment duration adjustment decision variable for the respective segment; and
a sum, with respect to the zero or more pinned words of the segments of translated speech in the translated transcript, of fifth result values, wherein, for a respective pinned word, the fifth result values include a result of subtracting a product of multiplying a third penalty value by a product of multiplying a product of multiplying two by the target temporal pinned-word start location for the respective pinned word by a value of the temporal pinned-word start location decision variable for the respective pinned word from a product of multiplying the third penalty value by a square of the value of the temporal pinned-word start location decision variable for the respective pinned word;
such that the constraints are satisfied.

15. A non-transitory computer-readable storage medium, comprising executable instructions that, when executed by a processor, facilitate performance of operations comprising:
obtaining an input video comprising:
a sequence of input images; and
input audio, wherein the input audio includes:
input speech audio in a first language; and
other audio;
automatically generating a dubbed video comprising the sequence of input images, the other audio, and segments of automatically generated synthesized speech audio in a second language, wherein automatically generating the dubbed video includes:
automatically generating a source transcript of the input speech audio in the first language using a machine learning speech recognition model;
automatically generating a translated transcript in the second language by translating the source transcript using a machine learning translation model;
automatically generating synthesis optimization data by solving a quadratic optimization problem formulated to synchronize the segments of automatically generated synthesized speech audio with the sequence of input images;
automatically synthesizing the segments of automatically generated synthesized speech audio in accordance with the synthesis optimization data and the translated transcript using a machine learning text-to-speech synthesis model; and
including the segments of automatically generated synthesized speech audio in the dubbed video in accordance with the synthesis optimization data; and
outputting the dubbed video.

16. The non-transitory computer-readable storage medium of claim 15, wherein automatically generating the synthesis optimization data includes:
obtaining optimization parameters data for a quadratic optimization problem, the optimization parameters data including:
an objective term, wherein the objective term includes:
a defined positive semi-definite matrix; and
a vector of decision variables;
a defined minimum segment duration adjustment value; and
a defined maximum segment duration adjustment value;
obtaining optimization input data including:
a segments cardinality parameter indicating a cardinality of segments of translated speech in the translated transcript; and
on a per segment basis for the segments of translated speech in the translated transcript:
a target segment-start temporal location;
a target segment-end temporal location;
a target segment duration adjustment value;
an unadjusted temporal segment duration value; and
a cardinality of pinned words, wherein, for the pinned words, on a per pinned word basis, the optimization input data includes:
a target temporal pinned-word start location; and
an unadjusted temporal pinned-word location offset with respect to the target segment-start temporal location;
formulating the quadratic optimization problem in accordance with the optimization parameters data and the optimization input data, wherein formulating the quadratic optimization problem includes formulating:
objective functions for the quadratic optimization problem; and
constraints for the quadratic optimization problem; and
determining the synthesis optimization data by solving the quadratic optimization problem, wherein solving the quadratic optimization problem includes, for a respective segment from the segments of automatically generated synthesized speech audio, determining values of the decision variables.

17. The non-transitory computer-readable storage medium of claim 16, wherein obtaining the optimization parameters data includes obtaining the vector of decision variables on a per segment basis for the segments of automatically generated synthesized speech audio, wherein, for a respective segment of the segments of automatically generated synthesized speech audio, obtaining the vector of decision variables comprises including, in the vector of decision variables:
a segment-start temporal location decision variable;
a segment-end temporal location decision variable;
a segment duration adjustment decision variable;
a successive segments temporal duration adjustment difference decision variable; and
on a per pinned word basis for zero or more pinned words of the respective segment, a temporal pinned-word start location decision variable.

18. The non-transitory computer-readable storage medium of claim 17, formulating the constraints includes:
formulating a cumulative temporal duration constraint indicating that a sum of adjusted segment durations for the segments of translated speech in the translated transcript is less than or equal to a duration of the input audio, wherein, for a respective segment from the segments of translated speech in the translated transcript, an adjusted segment duration is a product of multiplying a value of the segment duration adjustment decision variable for the respective segment and the unadjusted temporal segment duration value of the respective segment; and
formulating constraints on a per segment basis for the segments of translated speech in the translated transcript, wherein, for a respective segment from the segments of translated speech in the translated transcript, formulating the constraints includes formulating:
a segment overlap constraint indicating that a sum of a value of the segment-end temporal location decision variable for the respective segment and a defined inter-segment temporal duration is less than or equal to a value of a segment-start temporal location decision variable of a sequentially subsequent segment from the segments of translated speech in the translated transcript;
a duration adjustment constraint indicating that the value of the segment duration adjustment decision variable for the respective segment is greater than or equal to the defined minimum segment duration adjustment value and is less than or equal to the defined maximum segment duration adjustment value;
a temporal continuity constraint indicating that the value of the segment-end temporal location decision variable for the respective segment matches a sum of a value of the segment-start temporal location decision variable for the respective segment and the product of multiplying the value of the segment duration adjustment decision variable for the respective segment and the unadjusted temporal segment duration value of the respective segment;
a speed variation constraint indicating that a value of the successive segments temporal duration adjustment difference decision variable for the respective segment matches a result of subtracting the value of the segment duration adjustment decision variable for the respective segment from a value of the segment duration adjustment decision variable of a sequentially subsequent segment from the segments of translated speech in the translated transcript; and
a pinned temporal location constraint indicating that, on a per pinned word basis for the zero or more pinned words of the respective segment, a value of the temporal pinned-word start location decision variable of a respective pinned word matches a sum of the value of the segment-start temporal location decision variable of the respective segment and a product of the value of the segment duration adjustment decision variable of the respective segment and the unadjusted temporal pinned-word location offset of the respective pinned word.

19. The non-transitory computer-readable storage medium of claim 17, wherein formulating the objective functions includes formulating:
a per-segment start drift objective function indicating minimizing, for the segments of translated speech in the translated transcript, a sum of first squared differences, wherein the first squared differences include, for the respective segment, a square of a result of subtracting the target segment-start temporal location for the respective segment from a value of the segment-start temporal location decision variable for the respective segment;
a per-segment end drift objective function indicating minimizing, for the segments of translated speech in the translated transcript, a sum of second squared differences, wherein the second squared differences include, for the respective segment, a square of a result of subtracting the target segment-end temporal location for the respective segment from a value of the segment-end temporal location decision variable for the respective segment;
a speed drift objective function indicating minimizing, for the segments of translated speech in the translated transcript, a sum of squared values of the successive segments temporal duration adjustment difference decision variable, wherein, for the respective segment, the sum of squared values of the successive segments temporal duration adjustment difference decision variable includes a square of a value of the successive segments temporal duration adjustment difference decision variable for the respective segment;
an anchor speed drift objective function indicating minimizing, for the segments of translated speech in the translated transcript, a sum of third squared differences, wherein the third squared differences include, for the respective segment, a square of a result of subtracting the target segment duration adjustment value for the respective segment from a value of the segment duration adjustment decision variable for the respective segment; and
a pinned word drift objective function indicating minimizing, for the zero or more pinned words of the segments of translated speech in the translated transcript, a sum of fourth squared differences, wherein the fourth squared differences include, for a respective pinned word, a square of a result of subtracting the target temporal pinned-word start location for the respective pinned word from a value of the temporal pinned-word start location decision variable for the respective pinned word.

20. The non-transitory computer-readable storage medium of claim 17, wherein formulating the quadratic optimization problem includes formulating the quadratic optimization problem to:
minimize a sum of:
a sum, with respect to the segments of translated speech in the translated transcript, of first result values, wherein, for a respective segment from the segments of translated speech in the translated transcript, the first result values include a result of subtracting a product of multiplying a first penalty value by a product of multiplying a product of multiplying two by the target segment-start temporal location for the respective segment by a value of the segment-start temporal location decision variable for the respective segment from a product of multiplying the first penalty value by a square of the value of the segment-start temporal location decision variable for the respective segment;
a sum, with respect to the segments of translated speech in the translated transcript, of second result values, wherein, for the respective segment, the second result values include a result of subtracting a product of multiplying the first penalty value by a product of multiplying a product of multiplying two by the target segment-end temporal location for the respective segment by a value of the segment-end temporal location decision variable for the respective segment from a product of multiplying the first penalty value by a square of the value of the segment-end temporal location decision variable for the respective segment;
a sum, with respect to the segments of translated speech in the translated transcript, of third result values, wherein, for the respective segment, the third result values include a product of multiplying a second penalty value by a square of the value of the successive segments temporal duration adjustment difference decision variable for the respective segment;
a sum, with respect to the segments of translated speech in the translated transcript, of fourth result values, wherein, for the respective segment, the fourth result values include a result of subtracting a product of multiplying the second penalty value by a product of multiplying a product of multiplying two by the target segment duration adjustment value for the respective segment by a value of the segment duration adjustment decision variable for the respective segment from a product of multiplying the second penalty value by a square of the value of the segment duration adjustment decision variable for the respective segment; and
a sum, with respect to the zero or more pinned words of the segments of translated speech in the translated transcript, of fifth result values, wherein, for a respective pinned word, the fifth result values include a result of subtracting a product of multiplying a third penalty value by a product of multiplying a product of multiplying two by the target temporal pinned-word start location for the respective pinned word by a value of the temporal pinned-word start location decision variable for the respective pinned word from a product of multiplying the third penalty value by a square of the value of the temporal pinned-word start location decision variable for the respective pinned word;
such that the constraints are satisfied.
